(19) United States
(12) Patent Application Publication
(10) Pub. No.: US 2016/0037148 A1
(43) Pub. Date: Feb. 4, 2016

(54) 3D-MAPPED VIDEO PROJECTION BASED ON ON-SET CAMERA POSITIONING

(71) Applicant: LiveLocation, Inc., Venice, CA (US)

(72) Inventors: Taylor Jobe, Venice, CA (US); Elliot Jobe, Venice, CA (US)

(21) Appl. No.: 14/812,306

(22) Filed: Jul. 29, 2015

Related U.S. Application Data
(60) Provisional application No. 62/030,197, filed on Jul. 29, 2014.

(51) Int. Cl. H04N 9/31; G06T 7/60; G06K 9/52; G06T 7/00

(52) U.S. Cl. CPC H04N 9/3194; H04N 9/3185; G06T 7/0042; G06T 7/60; G06K 9/52

(57) ABSTRACT

The techniques described herein relate to front and/or rear projection of a rendered three-dimensional (3D) environment image with real-time perspective correction for on-set camera movement for any projection surface contour. In one particular embodiment, a position of an on-site front or rear projection surface is determined by a device, and the device maps a position and angle of an on-site camera in relation to the on-site projection surface. By then correlating the camera mapping to a corresponding position and angle of a virtual camera within a mapped 3D reference environment, the techniques herein can render a projection image to project onto the on-site projection surface based on a 3D perspective of the virtual camera correlated within the 3D reference environment. In another embodiment, a shape of the on-site projection surface may be determined, such that rendering the projection image is also based on the shape.

### RELATED APPLICATIONS

This application claims priority to U.S. Provisional Application No. 62/030,197, filed Jul. 29, 2014, entitled: “3D-MAPPED VIDEO PROJECTION BASED ON ON-SET CAMERA POSITIONING,” by Jobe et al., the contents of which are herein incorporated by reference.

### TECHNICAL FIELD

The present disclosure relates generally to video projection, and, more particularly, to front and/or rear projection of a rendered 3D environment image with real-time perspective correction for on-set camera movement for any projection surface contour.

### BACKGROUND

During film production, among other related practices, many special effects techniques are used, such as chroma-key compositing including the modern use of a “green screen,” where a simulated three-dimensional space is reproduced to virtually surround the physical objects. In addition, however, front (or rear) projection of an actual video onto a physical surface behind talent so as to make it look like the actors are truly in that environment has been in use since the 1930s. For such projection techniques, the projected background image is captured by shooting footage of an actual location (e.g., out the back window of a car), creating an image called a “backplate”. Once on-set with talent, the backplate is projected behind the talent and the on-set camera films both the talent and the projected backplate at the same time, creating a composite image that ideally makes it look as if the talent is a part of the projected background.

A significant limitation of the current backplate method is that the on-set camera needs to be co-located in the same relative position as the camera that originally recorded the backplate in order for the perspectives of both images to align and create a believable composite image. The farther the on-set camera position deviates from that of the original backplate camera's relative location, the more the perspectives of the two images diverge and the composite image becomes less believable.

The composite image's sensitivity to perspective divergence relates to the relative distance of the objects in the backplate scene from those of the subject. Perspective divergence may not be an issue if the objects in the backplate are relatively far from the subject and the objects perspective-shift is not noticeable to the viewer. For example, if the backplate consists only of clouds that are thousands of feet away, then the perspective divergence may not be noticed by the viewer. However, as the relative distance of scene elements on the backplate get closer to the subject, the impact of perspective divergence becomes critical to the integrity of the believability of the composited image.

Recently, computer generated imagery has begun to supplement pre-recorded footage as the image source for projected backplates. Generally, there is a “digital camera” that is pre-programmed into the computer model that is used to calculate what the rendered backplate should be. However, regardless of whether an image is recorded traditionally as footage or rendered from a computer generated source, the issue of perspective divergence remains unsolved and prevents front and/or rear projection from being a viable solution for most content being filmed.

### SUMMARY

According to one or more embodiments of the disclosure as described in greater detail below, techniques are described for front and/or rear projection with real-time perspective-shift of a projected backplate created from a three-dimensional (3D) reference environment that is corrected in real-time for the on-set camera's physical location on the stage and the shape and location of the projection surface.

In particular, in a filming environment, rear projection can be used to project an actual background image behind on-set actors/objects, rather than using chroma-keying (e.g., green-screens). In one embodiment of the present invention, the image that is actually projected is mapped in a 3D space, and correlated with the physical camera position on set in order to project a 3D-based perspective-appropriate image on a surface. As an example, if the projection appears behind a window built on set, a projected car parked outside would move differently than a building across the street, based on real-life perspective looking out the window from different locations in a room. Accordingly, the techniques herein map the projected space and display the projected image based on camera positioning to match the real-life movement of the background objects.

According to one specific embodiment described herein, a position of an on-site front or rear projection surface is determined by a device, and the device maps a position and angle of an on-site camera in relation to the on-site projection surface. By then correlating the camera mapping to a corresponding position and angle of a virtual camera within a mapped three-dimensional (3D) reference environment, the techniques herein can render a projection image onto the on-site projection surface based on a 3D perspective of the virtual camera correlated within the 3D reference environment. Note also that in another specific embodiment, a shape of the on-site projection surface may be determined, such that rendering the projection image is also based on the shape.

### BRIEF DESCRIPTION OF THE DRAWINGS

The foregoing and other objects, features, aspects and advantages of the embodiments disclosed herein will become more apparent from the following detailed description when taken in conjunction with the following accompanying drawings.

FIG. 1 illustrates an example simplified schematic diagram of a backplate projection based filming site.

FIG. 2 illustrates an alternative view of FIG. 1.

FIG. 3 illustrates an example of a 3D virtual environment.

FIG. 4 illustrates an example of on-site and virtual cameras with the same positioning.

FIG. 5 illustrates an example of a perspective-accurate captured image from the positioning in FIG. 4.

FIG. 6 illustrates an example of when the on-set camera is at a different position from the virtual camera and the corresponding rendered image.

FIG. 7 illustrates an example of the distorted captured image from camera positions in FIG. 6.

FIG. 8 illustrates an example of a projection image rendered to correct the backplate image by moving the virtual camera to the same position as mapped within the virtual environment, and determining dimensional corrections based on the position (and shape) of the virtual projection surface.

FIG. 9 illustrates an example of a corrected composite image captured from the camera positions and computed corrections from FIG. 8.

FIG. 10 illustrates an example simplified procedure for 3D-mapped video projection based on on-set camera positioning in accordance with one or more embodiments herein.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DESCRIPTION OF EXAMPLE EMBODIMENTS

Filming with special effects such as green screens or backplates allows people or objects to be added to an environment that would be too costly or resource-intensive to actually film. Instead, the environment may be created entirely using, artwork, separately filmed footage, or a computer. Use of such special effects is especially common in motion pictures, where the desired result is for the subject and background environment to appear to have been photographed or filmed at the same time and place with the same camera.

Achieving realistic images requires accurately coordinating several aspects of the image of the subject and the image of the background. As noted above, the current backplate method is sensitive to perspective divergence, which is critical to the integrity of the believability of the composited image, regardless of whether the backplate footage is produced traditionally with film or rendered from a computer generated source.

The techniques herein address the drawbacks associated with perspective divergence for backplates and are particularly directed to front and/or rear projection of a rendered 3D environment image with real-time perspective correction for on-set camera movement for any projection surface contour. In particular, according to one or more embodiments of the disclosure as described in detail below, the image that is actually projected is mapped in a 3D space, and correlated with the physical camera position on set in order to project a 3D-based perspective-appropriate image on a surface. That is, the techniques herein map the projected space and display the projected image based on camera positioning to match the real-life movement of the background objects.

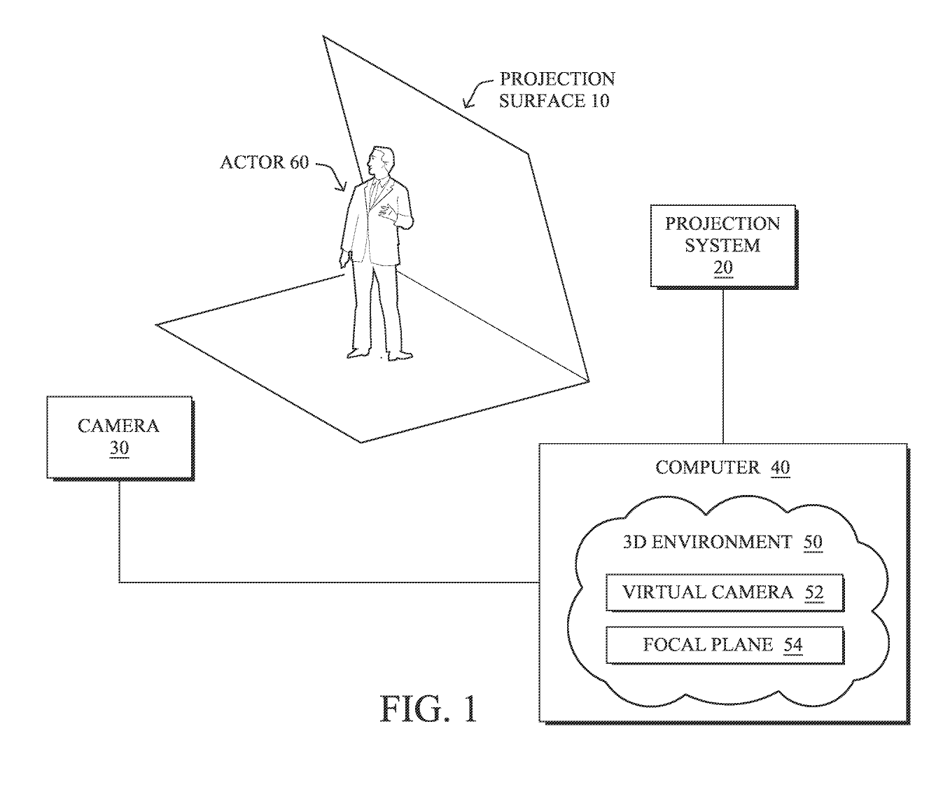

Illustratively, the techniques described herein may be performed by hardware, software, and/or firmware. In addition, the techniques herein may be treated as extensions to existing technologies and programming for backplate production, and as such, may be processed by similar components understood in the art that execute those techniques, accordingly. In particular, as described in greater detail below, and with general reference to FIG. 1, a simplified system 100 comprises an on-site projection surface 10 and projection system 20, an on-site camera 30, and a computer system 40 connected to the projection system 20 and camera 30. Within the computer system 40 is a stored/mapped three-dimensional (3D) reference environment 50 which includes a virtual camera 52 and a virtual projection surface “focal plane” 54, as described below. Also as shown is an actor 60 that may be an onset subject to be filmed in front of projection surface 10.

Computing system 40 may be of various forms of electronic devices operable to execute stored instructions via one or more processors of system 40. Specifically, computing system 40 may include stored instructions that, when executed, cause system 40 to implement virtual environment 50 including virtual camera 52 and virtual projection surface 54, as described herein. While a singular computing system 40 is shown, distributed computing systems may also be used in system 40, such as across different devices that communicate via a data network.

A primary goal of the techniques herein is to expand the utility of front/rear projection used in video filming by correcting the projected image to adjust for the perspective shift of the physical on-set camera. This will eliminate perspective divergence and allow the on-set camera and the projected backplate to have the same perspective, ultimately creating a believable integration of the subject and backplate composite image.

In order to accomplish this, the techniques herein use a computer system 40 to create the backplate image for projection that is rendered from the 3D reference environment 50, which includes a visual representation of every streetlight, tree, building, fence post, object, etc. at a specific mapped location within the environment. As noted above, within the 3D environment, there is also a “virtual” camera 52 that renders out the portion of the 3D environment that it sees through its virtual lens. For example, as the virtual camera pans left, the rendered image will pan left. As the virtual camera moves laterally, the rendered backplate will change to reflect the new visual field of the virtual camera.

Note that it is possible to perform real-time rendering from a virtual camera in a 3D environment, and this process may be used for real-time compositing of a filming subject on a green-screen stage. In this case, the image of the subject being recorded on-set is extracted from the green (or blue) background and may be virtually “displayed” onto the focal plane within the relative space of the 3D environment. By combining the “displayed” image of the subject onto the focal plane and dynamically moving the virtual camera and focal plane through the 3D environment according to the on-set camera's physical movements, the computer is able to render a composite image that looks like the subject is occupying the 3D environment. In this example, the image of the physical world (i.e., what the on-set camera is seeing and recording on-set of the subject) is pulled into the 3D digital environment and composited into a 2D image that maintains the same perspective of both cameras.

However, in order for a backplate projection rendered from the location of a virtual camera within a 3D environment to be projected into the physical world (that is, the opposite of the previous example), there are two major corrections that need to be made to the rendered backplate in order for the composite image being viewed by the on-set camera to maintain integrity of the perspective. First, the projected image needs to be corrected to eliminate the relative physical divergence of the virtual camera 52 and the on-set camera 30. Second, the projected image needs to be corrected based on the shape and position of the physical projection surface (projection surface 10) and the on-set camera's relative position to that surface. Accordingly, the techniques herein correct the projected backplate image to eliminate perspective divergence and account for physical camera movements, as well as to account for the size, shape and location of the projection surface relative to the on-set camera, thus maintaining a harmonious perspective integration of both the on-set camera and virtual camera.

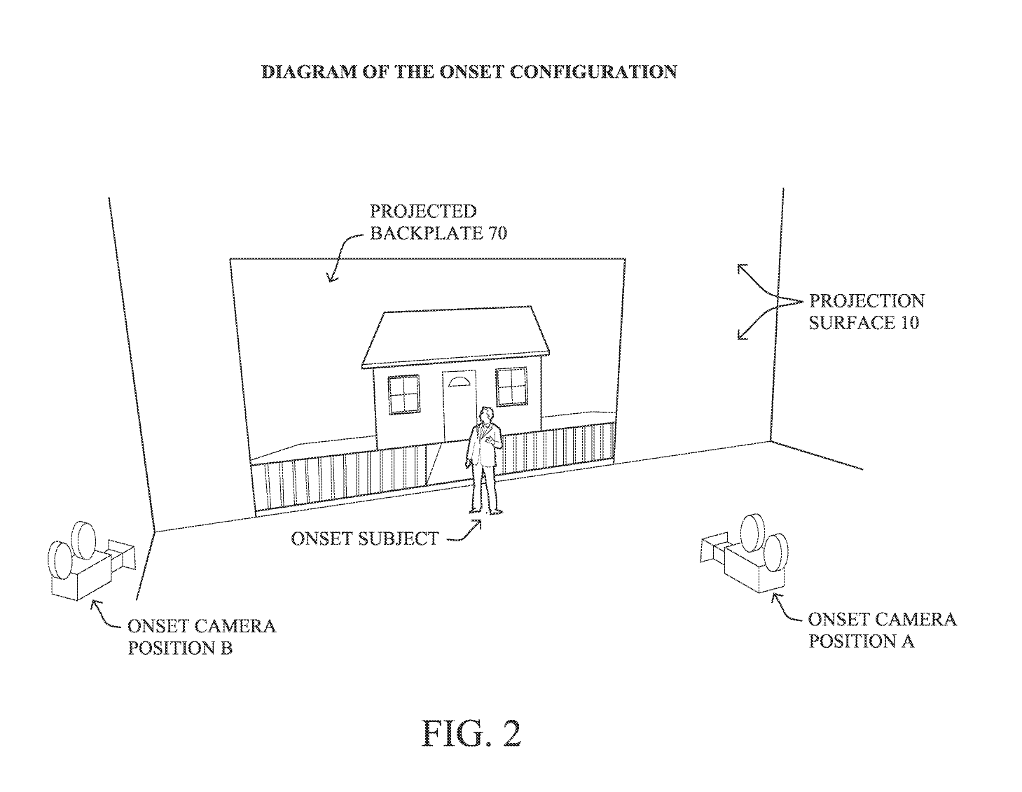

Operationally, and with general reference to FIGS. 2-9, the techniques herein accomplish this by physically tracking the on-set camera 30 in real-time by using its positional data to reposition the virtual camera to the appropriate corresponding location within the 3D environment. In this way the projected image will minor the perspective changes the physical on-set camera is seeing of the subject it is filming.

However, without any further correction this composite image will only maintain perspective integrity when the on-set camera and virtual camera's focal plane are the same as the projected surface plane. In other words, as the camera pans, tilts, and moves closer to or further from the projection surface plane, the perceived perspective will begin to diverge again. In order for the projected image to provide the correct perspective from the viewpoint of the on-set camera, a correction needs to be made to the rendered image the virtual camera is seeing that corrects for the physical movement of the on-set camera in relation to the projection surface(s).

Of key importance is the relation of the on-set & virtual camera to the projection surface. The projection surface can be a wall, screen, or other surface capable of showing a projection, such as televisions or other displays (e.g., LED, LCD, CRT, plasma, etc.). In addition, the projection surface 10 can be of any size and shape (e.g., rectangular, square, flat, rounded, curved, irregular, etc.). This can be corrected for by registering the projection surface within the 3D environment in its correct relative position as a focal plane 54, so that the final projected backplate 70 can be corrected based on both the shape of the projection surface 10 as well as the relation of the location of on-set camera 30 to projection surface 10.

Therefore, by taking into account the location of on-set camera 30 and using its position data to drive a corresponding movement of the virtual camera 52 in real-time and correcting the projected backplate 70 to account for the size, shape, and location of the projected surface 70 in relation to the location of on-set camera 30, it is possible to create an entirely accurate composite image using rear/front projection of a 3D reference environment as a backplate with physical on-set camera movements occurring real-time.

As an example, FIG. 2 illustrates an alternative view of FIG. 1, showing the projected projection surface 10 for an on-set arrangement, which includes the actor (on-set subject) 60 and on-set camera 30, shown with two demonstrative positions “A” and “B”. In addition, backplate 70 may be projected onto projection surface 10 behind subject 60.

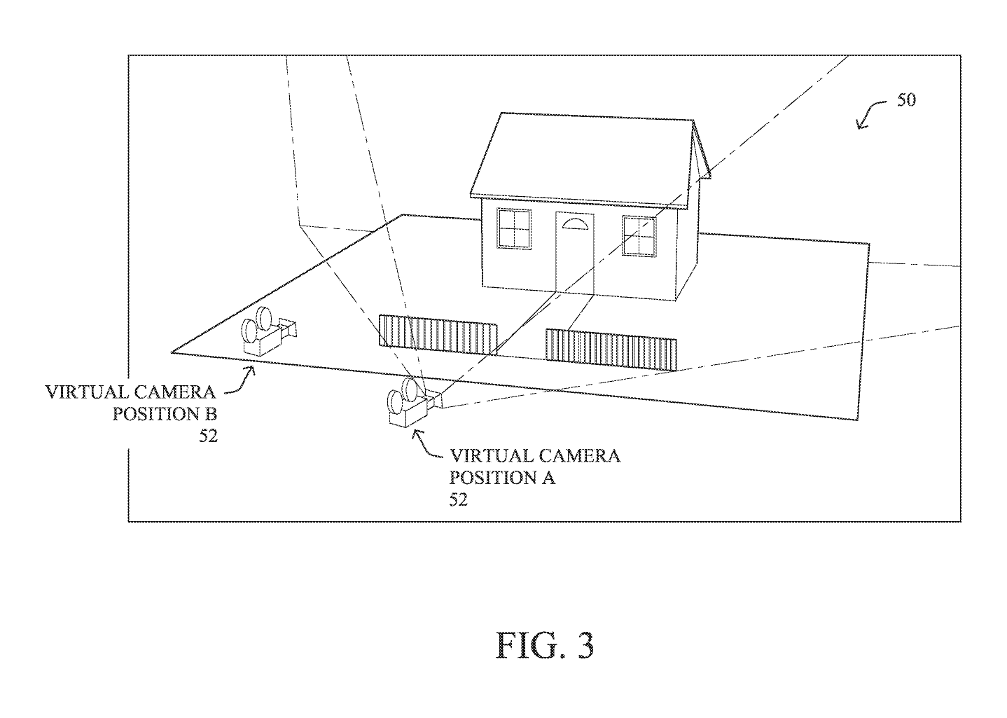

FIG. 3 illustrates an example of the 3D virtual environment 50 that has virtual camera 52 and corresponding demonstrative positions “A” and “B”. At these different positions, focal plane 54 may be determined within virtual environment 50 (e.g., to capture the house, etc. in virtual environment 50 from different angles). In various embodiments, a universal coordinate system may be used to represent the locations and angles between virtual/on-site cameras and the focal plane.

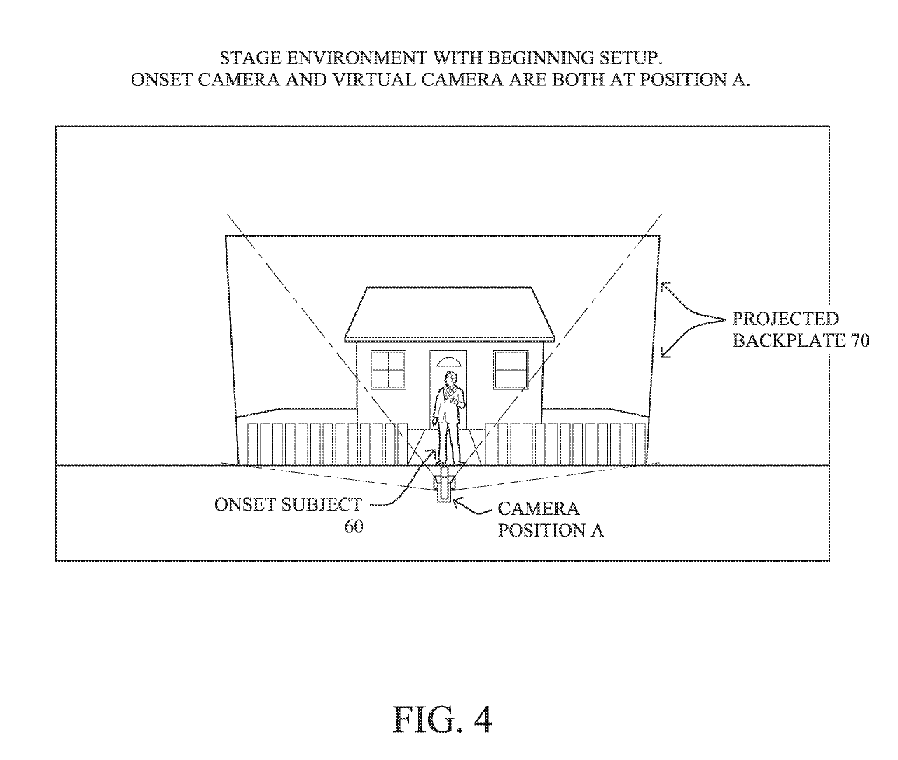

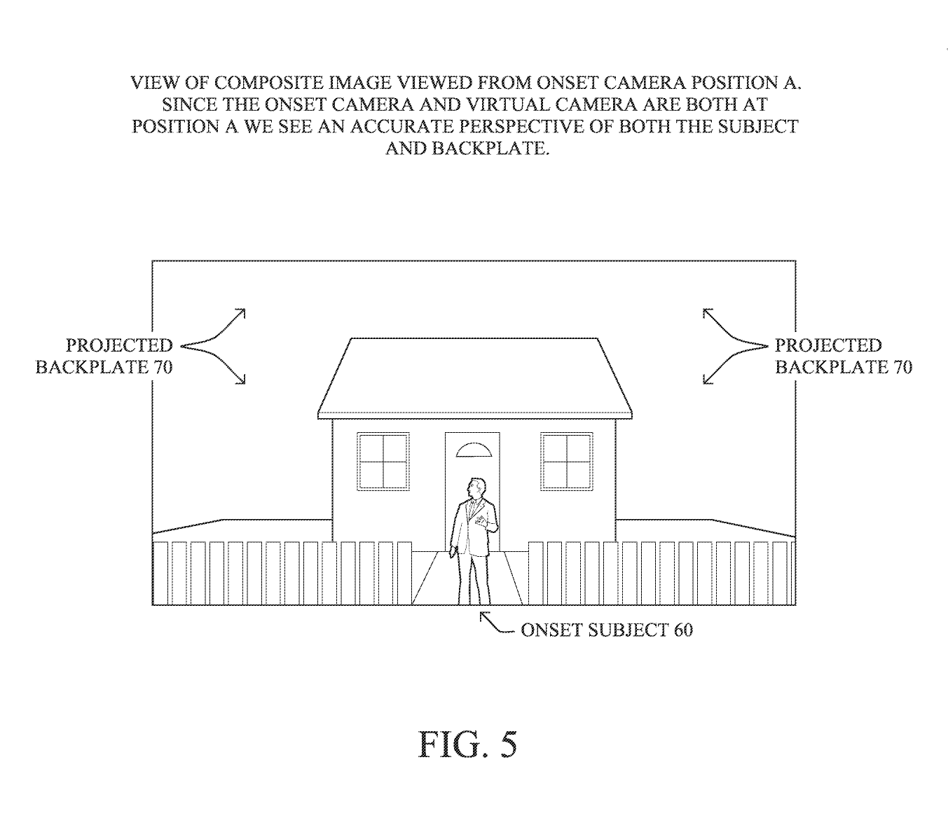

Referring to FIGS. 4-5, having the on-site camera 30 at position “A”, and the virtual camera 52 at position “A”, the rendered and projected image creates a perspective-accurate captured image. In other words, if both the real and virtual cameras match their locations and angles relative to the projected image, no perspective adjustments may be needed by system 40.

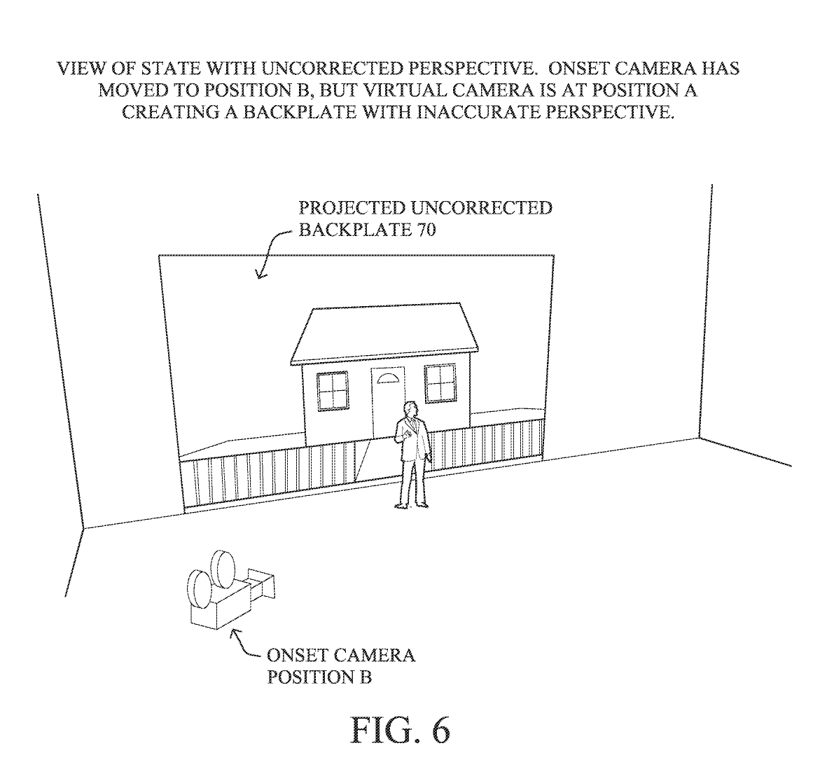

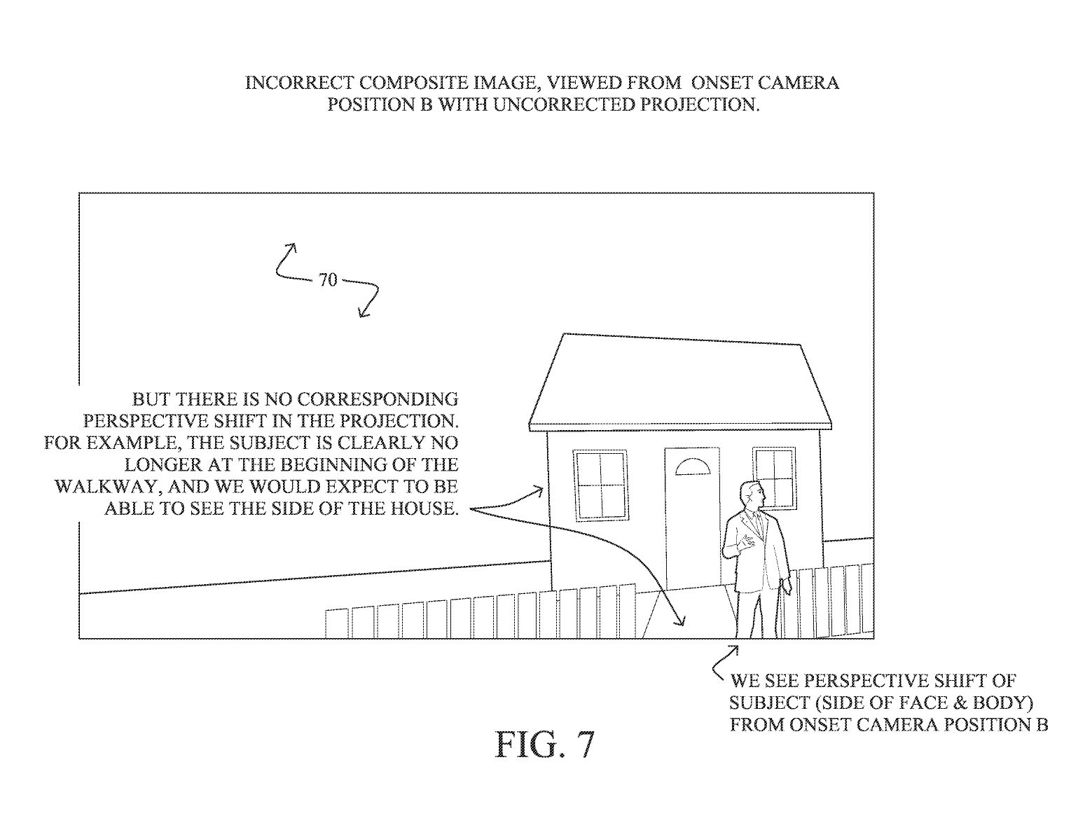

However, as shown in FIG. 6, when the on-set camera 30 is at position “B”, while the projected image 70 is still based on the rendered image from the virtual camera 52 at position “A”, the captured image from on-set camera position “B” is distorted, as shown in FIG. 7. For example, as shown, the side of the actor 60 is shown, but the side of the background house is not. Other distortions, such as the dimensions of the virtual objects (e.g., the house), also appear when the perspective is not appropriately managed.

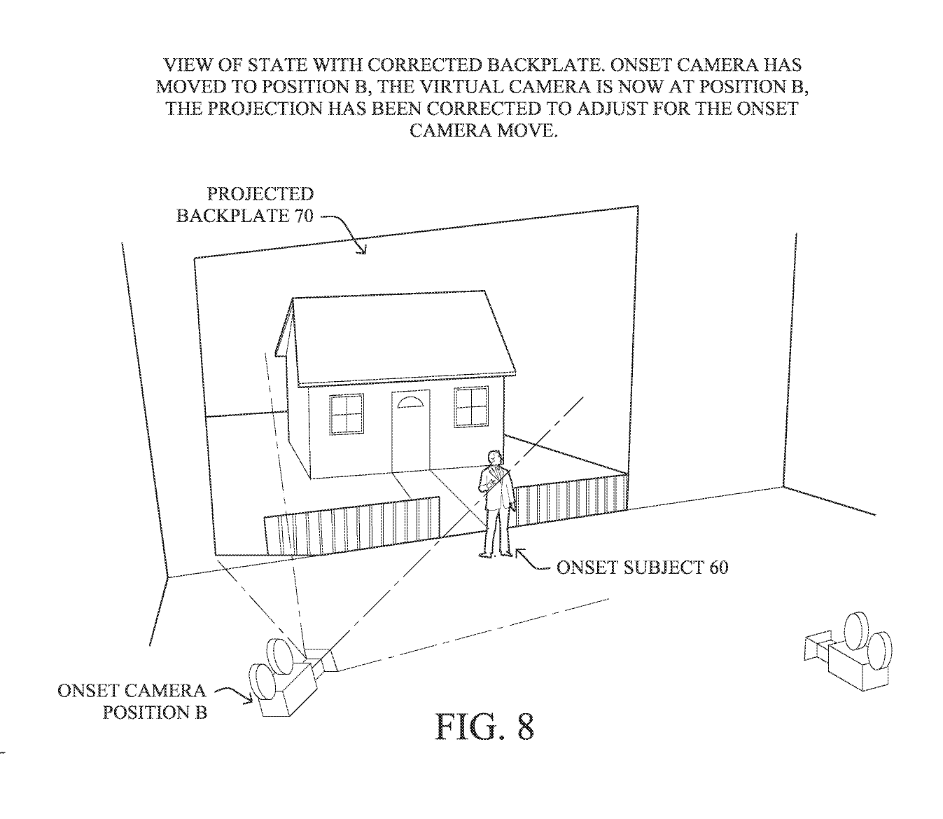

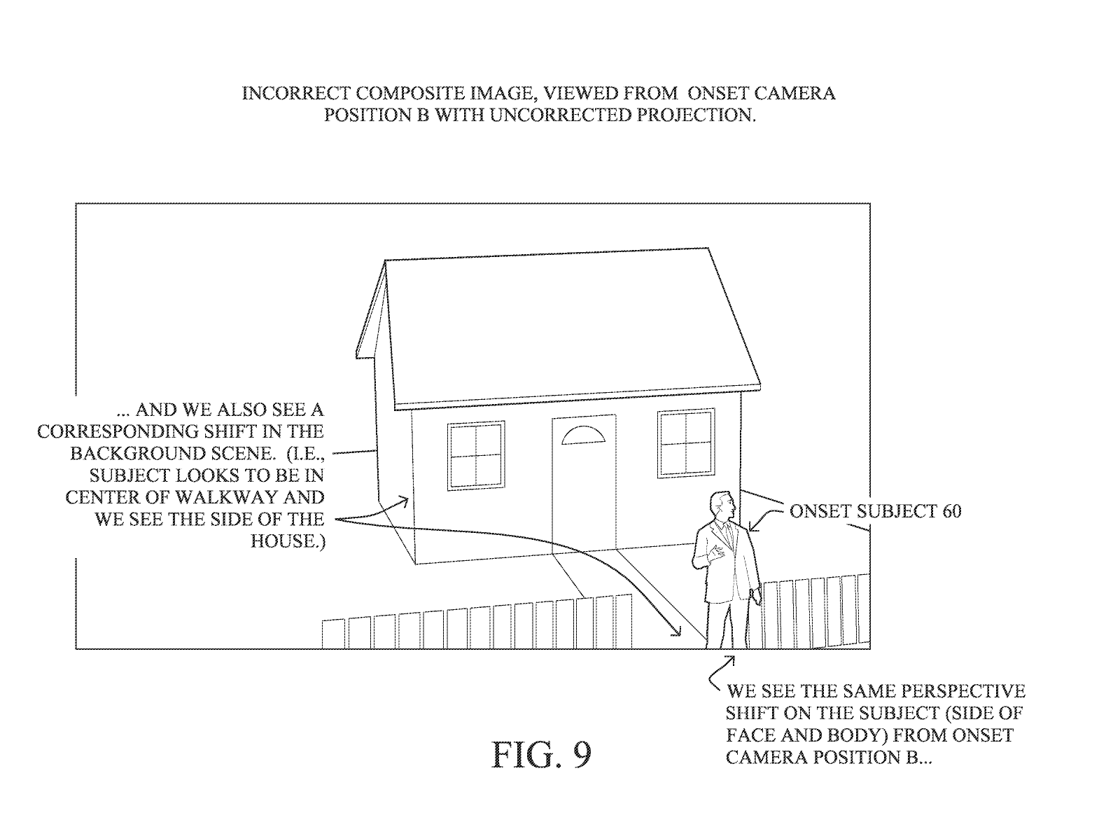

As such, as described herein, FIG. 8 represents a projection image 70 rendered to correct the backplate image by moving the virtual camera 52 to the same position “B” as mapped within the virtual environment 50, and determining dimensional corrections based on the position (and shape) of the virtual projection surface, i.e., focal surface/plane 54. In this manner, when filming with the on-set camera 30 with the projection computed as in FIG. 8, a corrected composite image may be captured as shown in FIG. 9.

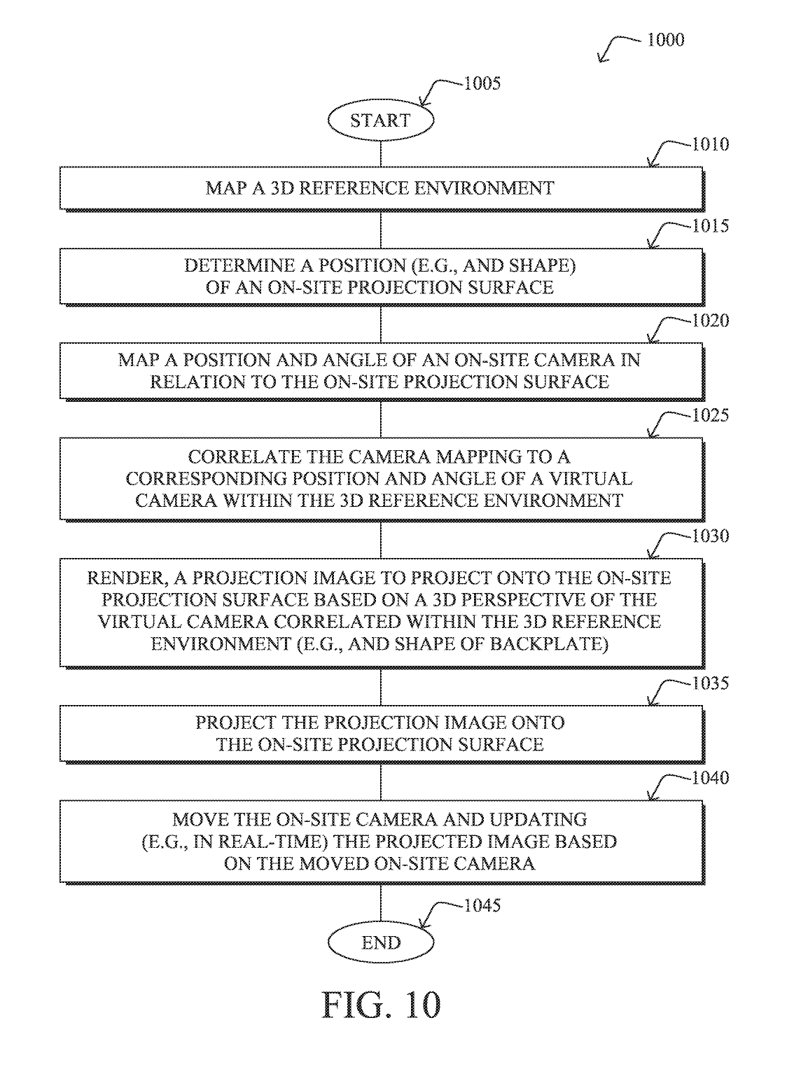

FIG. 10 illustrates an example simplified procedure 1000 for 3D-mapped video projection based on on-set camera positioning in accordance with one or more embodiments herein. The procedure 1000 may start at step 1005, and continues to step 1010, where, as described in greater detail above, a three-dimensional (3D) reference environment 50 is mapped (e.g., in advance by a graphical artist). In step 1015, a position of an on-site projection surface 10 (e.g., and a shape of the on-site projection surface) are determined, such that in step 1020 a position and angle of an on-site camera 30 can be mapped in relation to the on-site projection surface 10.

The computer 40 may then correlate the camera mapping to a corresponding position and angle of a virtual camera 52 within the 3D reference environment 50 in step 1025. In step 1030, the computer can then render a projection image (i.e., the backplate) to project onto the on-site projection surface 10 based on a 3D perspective of the virtual camera correlated within the 3D reference environment 50 (e.g., and shape of the projection surface) as described in detail above. For instance, as detailed above, rendering the projection image may be based on determining a position of a virtual projection surface within the 3D reference environment that corresponds to the position of the on-site projection surface, and determining a focal surface (focal plane 54) defined by the virtual projection surface within the 3D reference space. Rendering the projection image thus is based on determining what virtual image the virtual camera would visually capture within the 3D reference environment at the focal surface, and computing the projection image required to project the virtual image on the on-site projection surface such that the on-site camera would visually capture a live image projected on the on-site projection surface that is the same as the virtual image.

In step 1035, the projection image may be projected onto the on-site projection surface by projection system 20. Note that the on-site projection surface may be either part of a front projection or rear projection system, and as such, may use front or rear projection, respectively. Also note that where the on-site projection surface 10 is a television source, the “projecting” in step 1035 may comprise displaying the backplate image on that television-type projection surface, accordingly. (Note further that in this embodiment, projection system 20 and projecting surface 10 are embodied as the television, and are therefore generally co-located.) In the case of rear projection, rendering may require further computing the projection image to display the 3D perspective of the virtual camera on a front of the on-site projection surface (e.g., flipping, reversing, etc. of the image). As the on-site camera moves, the projected image is updated based on the moved on-site camera (e.g., occurring in real-time) in step 1040. That is, tracking on-set positional and angular data of the on-site camera allows appropriate mapping of the position and angle of the on-site camera.

The simplified procedure 1000 illustratively ends at step 1045. The techniques by which the steps of procedure 1000 may be performed, as well as ancillary procedures, parameters, and apparatuses performing the same, are described in detail above. It should be noted that certain steps within procedure 1000 may be optional, and the steps shown in FIG. 10 are merely examples for illustration. Certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for 3D-mapped video projection based on on-set camera positioning. In particular, the disclosed techniques and devices herein offer benefits for creativity, realism, and cost for almost any production that uses projection mapping to record content. For instance, in comparison to traditional rear/front projection, the complexity of the shots and diversity of environments that could be created with real-time perspective shift are unlimited. This leads to dramatically improved creativity and dynamism of the content being recorded. In addition, in comparison to green-screen compositing, the techniques herein alleviate the need for footage to be composited in post-production, since the actual compositing of the two images (talent and background) happen on-set in real time resulting in a recording of the final shot. This would add tremendous (e.g., more than 50%) cost savings since it effectively eliminates any compositing in post-production.

While there have been shown and described illustrative embodiments that provide for 3D-mapped video projection based on on-set camera positioning, it is to be understood that various other adaptations and modifications may be made within the spirit and scope of the embodiments herein, with the attainment of some or all of their advantages. For instance, it is expressly contemplated that the components and/or elements described herein may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion. Additionally, it is understood that a number of the devices and procedures herein may be executed by at least one controller. The term “controller” refers to a hardware device that includes a memory and a processor. The memory is configured to store program instructions, and the processor is specifically configured to execute said program instructions to perform one or more processes which are described further below. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
mapping, by an electronic device, a three-dimensional (3D) reference environment;
determining, by the device, a position of an on-site projection surface;
mapping, by the device, a position and angle of an on-site camera in relation to the on-site projection surface;
correlating, by the device, the camera mapping to a corresponding position and angle of a virtual camera within the 3D reference environment;
rendering, by the device, a projection image to project onto the on-site projection surface based on a 3D perspective of the virtual camera correlated within the 3D reference environment; and
projecting the projection image onto the on-site projection surface.

2. The method as in claim 1, further comprising:
determining a shape of the on-site projection surface;
wherein rendering the projection image is also based on the shape.

3. The method as in claim 1, wherein rendering comprises:
determining a position of a virtual projection surface within the 3D reference environment that corresponds to the position of the on-site projection surface; and
determining a focal surface defined by the virtual projection surface within the 3D reference space;
wherein rendering the projection image comprises determining what virtual image the virtual camera would visually capture within the 3D reference environment at the focal surface, and computing the projection image required to project the virtual image on the on-site projection surface such that the on-site camera would visually capture a live image projected on the on-site projection surface that is the same as the virtual image.

4. The method as in claim 1, further comprising:
moving the on-site camera; and
updating the projected image based on the moved on-site camera.

5. The method as in claim 4, wherein updating the projected image occurs in real-time.

6. The method as in claim 1, wherein mapping the position and angle of the on-site camera comprises:
tracking on-set positional and angular data of the on-site camera.

7. The method as in claim 1, wherein the on-site projection surface is configured for one of either front projection or rear projection, and wherein projecting comprises front or rear projection, respectively.

8. The method as in claim 7, wherein projecting comprises rear projection, and wherein rendering comprises:
computing the projection image to display the 3D perspective of the virtual camera on a front of the on-site projection surface.

9. The method as in claim 1, wherein the on-site projection surface is selected from a group consisting of: a screen; a wall; and a television.

10. A system, comprising:
an on-site projection surface and projection system;
an on-site camera; and
a computer system storing a mapping of a three-dimensional (3D) reference environment, the computer configured to:
determine a position of the on-site projection surface;
map a position and angle of the on-site camera in relation to the on-site projection surface;
correlate the camera mapping to a corresponding position and angle of a virtual camera within the 3D reference environment;
render a projection image to project onto the on-site projection surface based on a 3D perspective of the virtual camera correlated within the 3D reference environment; and
project the projection image onto the on-site projection surface with the projection system.

11. The system as in claim 10, wherein the computer system is further configured to:
determine a shape of the on-site projection surface;
wherein rendering the projection image is also based on the shape.

12. The system as in claim 10, wherein the computer system is further configured to render by:
determining a position of a virtual projection surface within the 3D reference environment that corresponds to the position of the on-site projection surface; and
determining a focal surface defined by the virtual projection surface within the 3D reference space;
wherein rendering the projection image comprises determining what virtual image the virtual camera would visually capture within the 3D reference environment at the focal surface, and computing the projection image required to project the virtual image on the on-site projection surface such that the on-site camera would visually capture a live image projected on the on-site projection surface that is the same as the virtual image.

13. The system as in claim 10, wherein the computer system is further configured to:
update the projected image based on movement of the on-site camera.

14. The system as in claim 13, wherein updating the projected image occurs in real-time.

15. The system as in claim 10, wherein the computer system is further configured map the position and angle of the on-site camera by:
tracking on-set positional and angular data of the on-site camera.

16. The system as in claim 10, wherein the on-site projection surface is configured for one of either front projection or rear projection, and wherein projecting comprises front or rear projection, respectively.

17. The system as in claim 16, wherein projecting comprises rear projection, and wherein the computer system is further configured to render by:
computing the projection image to display the 3D perspective of the virtual camera on a front of the on-site projection surface.

18. The system as in claim 10, wherein the on-site projection surface is selected from a group consisting of: a screen; a wall; and a television.

19. A tangible, non-transitory computer-readable media comprising software instructions, which when executed by a processor, are configured to:
map a three-dimensional (3D) reference environment;
determine a position of an on-site projection surface;
map a position and angle of an on-site camera in relation to the on-site projection surface;
correlate the camera mapping to a corresponding position and angle of a virtual camera within the 3D reference environment;
render a projection image to project onto the on-site projection surface based on a 3D perspective of the virtual camera correlated within the 3D reference environment; and
project the projection image onto the on-site projection surface.

20. The computer-readable media as in claim 19, wherein the software instructions, when executed by a processor, are further configured to:
determine a shape of the on-site projection surface;
wherein rendering the projection image is also based on the shape.
